(19) United States
(12) Patent Application Publication
(10) Pub. No.: US 2015/0117294 A1
(43) Pub. Date: Apr. 30, 2015

(54) METHOD AND APPARATUS FOR SUPPORTING FLEXIBLY CHANGING DUPLEX DIRECTIONS OF SUBFRAME IN TDD SYSTEM

(71) Applicant: Samsung Electronics Co., Ltd., Gyeonggi-do (KR)

(72) Inventors: Yingyang Li, Beijing (CN); Chengjun Sun, Bejing (CN)

(21) Appl. No.: 14/397,063

(22) PCT Filed: Apr. 26, 2013
(86) PCT No.: PCT/KR2013/003634

§ 371 Date: Oct. 24, 2014

(30) Foreign Application Priority Data
Apr. 27, 2012 (CN) 201210129650.7

(51) Int. Cl. H04W 72/04; H04L 5/00; H04W 4/06; H04L 5/14

(52) U.S. Cl. CPC H04W 72/042; H04L 5/14; H04L 5/0048; H04W 4/06; H04L 12/189
USPC 370/312; 370/280

(57) ABSTRACT

Disclosed is a method for supporting flexibly changing a duplex direction of a subframe in a Time Division Duplexing system including adjusting, by a base station, uplink-downlink subframe distribution in a frame structure of the base station, and scheduling uplink-downlink channel resources for User Equipment.

### TECHNICAL FIELD

The present invention relates to mobile communication technologies, more particularly to a method and apparatus for supporting flexibly changing a duplex direction of a subframe in a TDD system.

### BACKGROUND ART

Long Term Evolution (LTE) systems support work modes of Time Division Duplexing (TDD). FIG. 1 is a schematic diagram illustrating a frame structure in a TDD system. The length of each radio frame is 10 ms and the radio frame is divided into two half-frames with the length of 5 ms. Each half-frame includes eight time slots and three special fields. The length of each time slot is 0.5 ms. The special fields include a Downlink Pilot Time Slot (DwPTS) (100, 106), a Guard Period (GP) (102, 108), an Uplink Pilot Time Slot (UpPTS) (104, 110), and the total length of the DwPTS, GP, and UpPTS is lms. Each subframe consists of two continuous time slots, that is, the k^{th} subframe consists of a time slot 2k and a time slot 2k+1. The TDD system supports 7 uplink-downlink configurations, as shown in table 1. Herein, D indicates a downlink subframe, U indicates an uplink subframe, and S indicates a special subframe including the above three special fields.

TABLE 1

| Con- | switching | | | | | | | | | | |
|---|---|---|---|---|---|---|---|---|---|---|---|
| figuration | point | subframe number | | | | | | | | | |
| number | cycle | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 10 ms | D | S | U | U | U | D | S | U | U | D |

Table 1 examplifies an uplink-downlink configuration of LTE TDD.

According to specifications of the LTE TDD, the DwPTS in each of subframe 0, subframe 5, subframe 1 and the DwPTS in subframe 6 must be used for downlink transmission; the UpPTS in each of subframe 2, subframe 1 and the UpPTS in subframe 6 must be used for uplink transmission. Other five subframes, i.e. subframe 3, 4, 7, 8 and 9 may be downlink subframes in some uplink-downlink configurations and may be uplink subframes in other uplink-downlink configurations.

In conventional specifications of the LTE TDD, the uplink-downlink configuration used by a cell is configured via broadcast signaling, i.e. is included in System Information Block 1 (SIB1). Thus, the uplink-downlink configuration can be changed every 640 ms at fast in the LTE system, and system information can be changed up to 32 times within 3 hours according to conventional specifications. Currently, for the purpose of faster matching the change of service characteristic, 3GPP organization is researching how to support the faster changing of assignment of uplink-downlink subframes, for example, how to support the faster changing of uplink-downlink configuration, i.e. every 200 ms; or how to support the changing of uplink-downlink configuration within the level of 10 ms of the radio frame. In fact, a base station scheduler changes uplink-downlink subframe distribution according to services requirements and keep the system work normally by using certain scheduling limits, while UE does not need to know the uplink-downlink configuration currently used which is one of the above 7 uplink-downlink configurations. The uplink-downlink subframe distribution used practically is not limited in the above 7 uplink-downlink configurations exemplified in Table 1. In a word, the practical uplink-downlink configuration is transparent for the UE.

### DISCLOSURE OF INVENTION

### Technical Problem

In the system, if the uplink-downlink subframe distribution used by the cell can change flexibly, it is possible that a certain subframe is used for uplink transmission in some cells and is used for downlink transmission in other cells, which will cause the change of interference. For the cell in which the uplink transmission is performed, the uplink signals of the UE will suffer interference from downlink signals of adjacent base stations; for the cell in which the downlink transmission is performed, the downlink signals sent to the UE will suffer interference from uplink signals of the adjacent base stations. The problem of how to reduce the interference as much as possible needs to be solved in the system supporting flexibly changing the uplink-downlink subframe distribution.

The present invention provides a method and apparatus for supporting flexibly changing a duplex direction of a subframe in a TDD system, so as to reduce interference caused by flexibly changing the duplex directions of the subframe.

### Solution to Problem

The present invention provides a method for supporting flexibly changing a duplex direction of a subframe in a TDD system, the method includes:

adjusting, by a base station, uplink-downlink subframe distribution in a frame structure of the base station, and scheduling uplink-downlink channel resources for UE;

receiving and sending, by the base station, uplink-downlink data of the UE; for a subframe with a variable duplex direction, configuring a transmission method in the subframe according to a current duplex direction of the subframe and a duplex direction of the subframe in System Information Block 1 (SIB1) backward uplink-downlink configuration.

Preferably, for the subframe with the variable duplex direction, when the current duplex direction is a downlink direction, if the subframe is configured as a downlink subframe in the SIB1 backward uplink-downlink configuration, working according to common reference signal (CRS) configuration of the subframe in the SIB1 backward uplink-downlink configuration.

Preferably, for the subframe with the variable duplex direction, when the current duplex direction is a downlink direction, if the subframe is configured as an uplink subframe in the SIB1 backward uplink-downlink configuration, configuring CRS for the subframe according to a Multicast Broadcast Single Frequency Network (MBSFN) subframe.

Preferably, for the subframe with the variable duplex direction, when the current duplex direction is a downlink direction, if the subframe is configured as an uplink subframe in the SIB1 backward uplink-downlink configuration, not sending a CRS in the subframe.

Preferably, for the subframe with the variable duplex direction, if the subframe is configured as an uplink subframe in the SIB1 backward uplink-downlink configuration, indicating CRS configuration of the subframe when the duplex direction of the subframe is the downlink direction via a high layer signaling.

Preferably, configuring different transmission modes for a subframe with a fixed duplex direction and a flexible subframe with the current duplex direction of which is identical with the fixed duplex direction; or configuring same transmission modes for all of subframes with the same duplex direction.

Preferably, for a downlink subframe with a CRS in a subframe data part, configuring one of a transmission mode based on a CRS and a transmission mode based on a DeModulation Reference Signal (DMRS) in a Long Term Evolution (LTE) system; for a downlink subframe without the CRS in the subframe data part, configuring a Physical Downlink Shared Channel (PDSCH) transmission mode based on DMRS demodulation;

or, for all of the downlink subframes, configuring the PDSCH transmission mode based on DMRS demodulation.

Preferably, for the subframe with the variable duplex direction, if the subframe is configured as an uplink subframe in the SIB1 backward uplink-downlink configuration, when the current duplex direction is a downlink direction, scheduling uplink-downlink data based on a Enhanced-Physical Downlink Control Channel (E-PDCCH), or scheduling uplink-downlink data via a method based on cross-subframe scheduling.

Preferably, for the subframe with the variable duplex direction, if the subframe is configured as an uplink subframe in the SIB1 backward uplink-downlink configuration, when the current duplex direction is a downlink direction, only supporting a UE specific E-PDCCH Search Space (USS) without supporting a cell-common E-PDCCH Search Space (CSS), or supporting both the USS and the CSS.

Preferably, for the subframe with the variable duplex direction, if the current duplex direction is an uplink direction,

sending uplink scheduling control signaling of the subframe with the variable duplex direction only via a subframe fixedly being a downlink subframe;

or, sending uplink scheduling control signaling of the subframe with the variable duplex direction only via a subframe configured as a downlink subframe in the SIB1 backward uplink-downlink configuration;

or, sending uplink scheduling control signaling of the subframe with the variable duplex direction via a subframe fixedly being a downlink subframe and via a subframe with the variable duplex direction and a current duplex direction is a downlink direction.

The present invention provides a method for supporting flexibly changing a duplex direction of a subframe in a TDD system, the method includes:

receiving, by UE, downlink control information sent by a base station, for a subframe with a variable duplex direction, configuring a transmission method in the subframe according to a duplex direction of the subframe in System Information Block 1 (SIB1) backward uplink-downlink configuration and the downlink control information sent by the base station;

sending, by the UE, uplink data or receiving, by the UE, downlink data, according to the downlink control information sent by the base station.

Preferably, for the subframe with the variable duplex direction, when the current duplex direction is a downlink direction, if the subframe is configured as a downlink subframe in the SIB1 backward uplink-downlink configuration, working according to common reference signal (CRS) configuration of the subframe in the SIB1 backward uplink-downlink configuration.

Preferably, for the subframe with the variable duplex direction, when the current duplex direction is a downlink direction, if the subframe is configured as an uplink subframe in the SIB1 backward uplink-downlink configuration, working according to CRS configuration of a Multicast Broadcast Single Frequency Network (MBSFN) subframe.

Preferably, for the subframe with the variable duplex direction, when the current duplex direction is a downlink direction, if the subframe is configured as an uplink subframe in the SIB1 backward uplink-downlink configuration, working according to that a CRS is not comprised in the subframe.

Preferably, for the subframe with the variable duplex direction, if the subframe is configured as an uplink subframe in the SIB1 backward uplink-downlink configuration, receiving CRS configuration of the subframe indicated by a high layer signaling when the duplex direction of the subframe is the downlink direction.

Preferably, configuring different transmission modes for a subframe with a fixed duplex direction and a flexible subframe with the current duplex direction of which is identical with the fixed duplex direction; or configuring same transmission modes for all of subframes with the same duplex direction.

Preferably, for a downlink subframe with a CRS in a subframe data part, configuring one of a transmission mode based on a CRS and a transmission mode based on a DeModulation Reference Signal (DMRS) in a Long Term Evolution (LTE) system; for a downlink subframe without the CRS in the subframe data part, configuring a Physical Downlink Shared Channel (PDSCH) transmission mode based on DMRS demodulation;

or, for all of the downlink subframes, configuring the PDSCH transmission mode based on DMRS demodulation.

Preferably, for the subframe with the variable duplex direction, if the subframe is configured as an uplink subframe in the SIB1 backward uplink-downlink configuration, when the current duplex direction is a downlink direction, detecting E-PDCCH for scheduling uplink-downlink data, or detecting the downlink control information for scheduling the subframe by using a method based on cross-subframe scheduling.

Preferably, for the subframe with the variable duplex direction, if the subframe is configured as an uplink subframe in the SIB1 backward uplink-downlink configuration, when the current duplex direction is a downlink direction, only supporting a USS without supporting a CSS, or supporting both the USS and the CSS.

Preferably, for the subframe with the variable duplex direction, if the current duplex direction is an uplink direction,

detecting uplink scheduling control signaling of the subframe with the variable duplex direction only from a subframe fixedly being a downlink subframe;

or, detecting uplink scheduling control signaling of the subframe with the variable duplex direction only from a subframe configured as a downlink subframe in the SIB1 backward uplink-downlink configuration;

or, detecting uplink scheduling control signaling of the subframe with the variable duplex direction from a subframe fixedly being a downlink subframe and from a subframe with the variable duplex direction and a current duplex direction is a downlink direction.

The present invention provides a base station, used to support flexibly changing a duplex direction of a subframe in a TDD system, the base station includes:

an adjusting module, adapted to adjust uplink-downlink subframe distribution in a frame structure of the base station, and schedule uplink-downlink channel resources for UE;

a transceiving module, adapted to receive and send uplink-downlink data of the UE, for a subframe with a variable duplex direction, configure a transmission method in the subframe according to a current duplex direction of the subframe and a duplex direction in SIB1 backward uplink-downlink configuration.

The present invention provides a UE, used to support flexibly changing a duplex direction of a subframe in a TDD system, the UE includes:

a detecting module, adapted to receive downlink control information sent by a base station, for the subframe with a variable duplex direction, determine a transmission method in the subframe according to a duplex direction of the subframe in SIB1 backward uplink-downlink configuration and received downlink control information sent by the base station;

a transceiving module, adapted to send uplink data or receive downlink data according to the downlink control information sent by the base station.

### Advantageous Effects of Invention

By using the solutions of the present invention, the interference for uplink transmission of other cells caused by the CRS is avoided, and the CRS of the cell is not interfered by the uplink transmission of the other cells, thereby reducing the interference caused by flexibly changing the duplex direction of the subframe and further improving channel estimation precision.

### BRIEF DESCRIPTION OF DRAWINGS

FIG. 1 is a schematic diagram illustrating a frame structure in a TDD system.

FIG. 2 is a schematic flowchart illustrating processing on a base station side according to the present invention.

FIG. 3 is a schematic diagram illustrating CRS configuration according to the present invention.

FIG. 4 is a schematic flowchart illustrating processing on a UE side according to the present invention.

FIG. 5 is a schematic diagram illustrating the structure of a base station according to the present invention.

FIG. 6 is a schematic diagram illustrating the structure of UE according to the present invention.

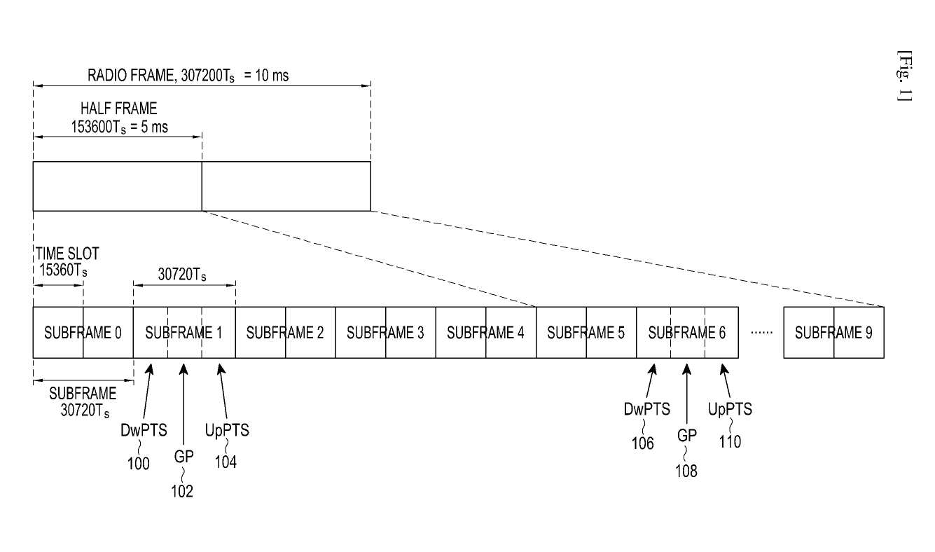

### MODE FOR THE INVENTION

The present invention is hereinafter further described in detail with reference to the accompanying drawings as well as embodiments so as to make the objective, technical solution and merits thereof clearer.

In conventional TDD systems, the uplink-downlink configuration used by a base station is sent via broadcast signaling SIB1, and changing the uplink-downlink configurations semi-statically is supported. Because the uplink-downlink configuration changes slowly, the case that the uplink-downlink configuration changes is not optimized in the conventional system. Practically, in the conventional TDD system, UE always works according to the uplink-downlink configuration sent by the current SIB1, and ensures that it is not confused at the junction when the uplink-downlink configuration changes semi-statically via base station implementation.

In a TDD system in which uplink-downlink subframe distribution can be configured flexibly, for the purpose of backward compatible, a uplink-downlink configuration still needs be sent in the broadcast channel SIB1, all of the UEs in the cell can receive this signaling which is called as a SIB1 backward uplink-downlink configuration hereinafter. The UEs can be divided into two types according to whether the UE supports a function of flexibly configuring uplink-downlink subframe distribution. The UE of the first type does not support the function of flexibly configuring uplink-downlink subframe distribution. This type of UE can only work according to the backward uplink-downlink configuration broadcasted by the SIB1. If the base station changes the transmission direction of some subframe, the base station scheduler is used to avoid scheduling the uplink-downlink transmission of the UE of the first type in the subframe with changed duplex direction, so as to ensure the uplink-downlink transmission of the UE of the first type is normal. The UE of the second type supports the function of flexibly configuring uplink-downlink subframe distribution. The method of the present invention is applied for the UEs of the second type and is to optimize system performance via changing the actions of the UE of the second type.

The advantages of flexibly configuring the uplink-downlink subframe distribution include that the base station is able to adjust the uplink-downlink subframe distribution according to current uplink-downlink service distribution, thereby optimizing system performance. Correspondingly, problems are caused that some flexible subframe is used for uplink transmission in some cells and is used for downlink transmission in other cells, and interference is brought between the uplink-downlink transmissions. Specifically, for the cell in which the uplink transmission is performed, uplink signals of the UE will suffer interference from downlink signals of adjacent base stations; for the cell in which the downlink transmission is performed, downlink signals sent to the UE will suffer interference from uplink signals of adjacent base stations.

For the uplink transmission, the uplink signals are scheduled by the base station and an uplink reference signal is limited in a Physical Resource Block (PRB) of a PUSCH assigned to the UE, so it is easy to control the interference caused by the uplink transmission in the flexible subframe. For the downlink transmission, if a Common Reference Signal (CRS) is configured in the subframe, no matter whether the current subframe sends the downlink data practically, the CRS needs to be sent by using large power. On the one hand, the base station can not control the interference caused by the CRS for the uplink transmission of adjacent cells; on the other hand, CRS-based channel estimation also receives the interference caused by uplink signals of other cells, which is not conducive to improving the accuracy of channel estimation. In the conventional LTE system, the CRS in the subframe may be reduced via configuring a Multimedia Broadcast/Multicast Service Single Frequency Network (MBSFN) subframe, that is, the CRS is sent only via the first one or two OFDM (Orthogonal Frequency Division Multiplexing) symbols in the subframe. Because the CRS still needs to be sent, this method can only reduce the impact of the CRS to a certain extent.

In order to solve the above interference problems, the present invention puts forwards: for the subframe with a variable duplex direction (i.e., uplink or downlink), when a current duplex direction is a downlink direction, the CRS in the subframe is configured respectively according to the duplex direction in the SIB1 backward uplink-downlink configuration which may be an uplink direction or a downlink direction.

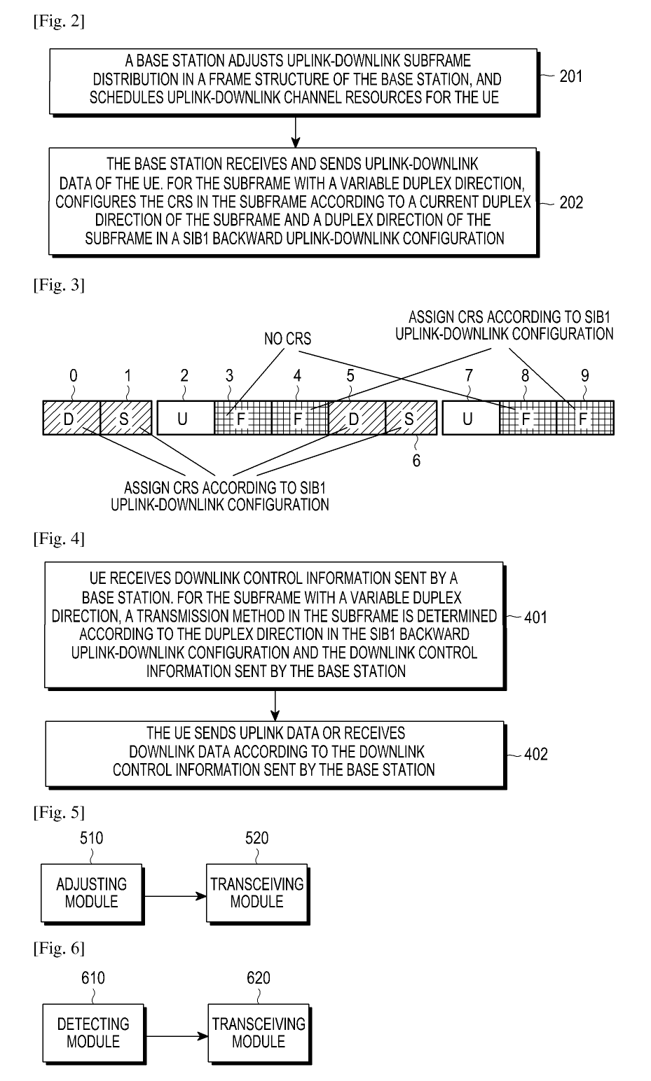

FIG. 2 is a schematic flowchart illustrating processing on a base station side according to the present invention.

In block 201: a base station adjusts uplink-downlink subframe distribution in a frame structure of the base station, and schedules uplink-downlink channel resources for the UE.

The base station may adjust the uplink-downlink subframe distribution according to current uplink-downlink service traffic distribution. For example, if the current downlink service traffic increases, the base station switches to the uplink-downlink configuration in which the downlink subframe has a greater proportion, vice versa.

In block 202: the base station receives and sends uplink-downlink data of the UE. For the subframe with a variable duplex direction, configures a transmission method in the subframe according to a current duplex direction of the subframe and a duplex direction of the subframe in a SIB1 backward uplink-downlink configuration.

Specifically, in block 202:

for the subframe without the variable duplex direction, if the duplex direction is configured as a downlink direction in the SIB1 backward uplink-downlink configuration, the subframe works according to the CRS configuration of the subframe in the SIB1 backward uplink-downlink configuration (i.e. the same as that in the prior art).

For the subframe with the variable duplex direction, when the current duplex direction is the downlink direction, if the subframe is configured as the downlink subframe in the SIB1 backward uplink-downlink configuration, the subframe also works according to the CRS configuration of the subframe in the SIB1 backward uplink-downlink configuration. When the subframe is a normal downlink subframe, the CRS is sent in the whole subframe, so that downlink data transmission is processed according a method in the normal downlink subframe. When the subframe is a MBSFN subframe, the CRS is sent in the first one or two DFDM symbols of the subframe, so that the downlink data transmission in such downlink subframe is processed by using a method for sending unicast services in the MBSFN subframe.

For the subframe with the variable duplex direction, when the current duplex direction is the downlink direction, if the subframe is configured as the uplink subframe in the SIB1 backward uplink-downlink configuration, the downlink transmission in such flexible subframe may be processed according to the following three methods.

In the first method, for such flexible subframe, the CRS is configured according to the MBSFN subframe, that is, the CRS is sent only in the first one or two DFDM symbols of the subframe, so that the downlink data transmission in such downlink subframe is processed by using the method for sending unicast services in the MBSFN subframe.

In the second method, for such flexible subframe, no CRS is sent in the whole subframe, so as to completely avoid the interference between cells caused by the CRS in the flexible subframe used for the downlink transmission, and avoid reducing of the channel estimation performance caused by the interference for the CRS.

In the third method, for such flexible subframe, the CRS is configured according to the normal downlink subframe, so that the downlink data transmission is processed according to the method in the normal downlink subframe.

The advantages of the first method include that: the backward compatible control channel of the control area of the subframe (Physical Control Format Indicator Channel (PCFICH), Physical Hybrid ARQ Indicator Channel (PHICH) and Physical Downlink Control Channel (PDCCH)) still can be sent, and the system in which the uplink-downlink subframe distribution can be flexibly configured may work completely according to the backward compatible control channel, at the same time, the uplink-downlink data transmission can be scheduled by using an Enhanced-PDCCH (E-PDCCH). The E-PDCCH is transmitted by the data area mapping to the subframe. In addition, by using this method, the CRS is only remained in the control area of the subframe, and thus the interference of the CRS is controlled to a certain extent.

The advantages of the second method include that: the CRS is totally cancelled from the subframe, and thereby avoiding the interference caused by the CRS for the uplink transmission of other cells, and avoiding the interference for the CRS of the cell caused by the uplink transmission of other cells, which further affects precision of the channel estimation.

The present invention is described in detail by taking the second method as an example.

As shown in FIG. 3, the SIB1 backward uplink-downlink configuration is uplink-downlink configuration 1, subframes 3, 4, 8 and 9 are subframes with variable duplex direction. According to the second method of the present invention:

the subframes 0, 1, 5 and 6 are always used for the downlink transmission, and thus the subframe 0, 1, 5 and 6 work respectively according to the CRS configuration in the SIB1 backward uplink-downlink configuration 1;

the flexible subframes 4 and 9 are downlink subframes in the SIB1 backward uplink-downlink configuration 1, and thus when the current duplex direction is the downlink direction, the flexible subframes 4 and 9 work respectively according to the CRS configurations in the SIB1 backward uplink-downlink configuration 1;

the flexible subframes 3 and 8 are uplink subframes in the SIB1 backward uplink-downlink configuration 1, and thus when the current duplex direction is the downlink direction, no CRS is sent in the whole subframes according to the second method of the present invention;

in addition, the subframes 2 and 7 are always used for the uplink transmission, and thus the subframes 2 and 7 work respectively according to the method in the SIB1 backward uplink-downlink configuration 1.

If such flexible subframe is the uplink subframe in the SIB1 backward uplink-downlink configuration, it may be pre-defined in the specification that one of the above three methods is used when the duplex direction is the downlink direction. The second method above is optimal from the point of view of interference suppression.

In addition, if such flexible subframe is the uplink subframe in the SIB1 backward uplink-downlink configuration, the base station can indicate the CRS configuration used when the duplex direction of the subframe is the downlink direction via sending signaling. For example, one of the above three methods may be indicated by using a high layer signaling, e.g. may be indicated by 2 bits. Or, the system only supports two of the three methods, one of the two methods may be indicated by using the high layer signaling, e.g. may be indicated by 1 bit. For example, by using the high layer signaling, it may be configured that the CRS is configured according the first or third method, or according to the first or second method, or according to the second or third method. The high layer signaling may be broadcast signaling and thus may be applied for all of the UEs which work in the flexible subframe mode in the cell; or the high layer signaling may be UE specific RRC signaling, and thus each UE in the cell may be configured respectively.

In the block 202, for the TDD system in which the uplink-downlink subframe distribution can be flexible configured, the interference in the subframe with fixed duplex direction and the interference in the subframe with flexible duplex direction are different. Specifically, the interference in the subframe with fixed downlink direction and the interference in the flexible subframe with the downlink direction as the current duplex direction are different; the interference in the subframe with fixed uplink direction and the interference in the flexible subframe with the uplink direction as the current duplex direction are different. Hence, different subframes have different best transmission modes. In one processing method, different transmission modes are respectively configured for the subframe with fixed duplex direction and the flexible subframe with the same duplex direction as the current duplex direction. For example, the subframe with fixed downlink direction is configured to support a downlink MIMO transmission mode, while the flexible subframe with the downlink direction as the current duplex direction is configured to only support a downlink transmission mode of transmit diversity; or the subframe with fixed uplink direction is configured to support a uplink MIMO transmission mode, while the flexible subframe with the uplink direction as the current duplex direction is configured to only support a uplink transmission mode of single antenna. Or in another processing method, the same transmission mode is configured for all of the subframes with the same duplex direction. For example, the base station scheduler guarantees the proper adaptive Modulation and Coding Scheme (MCS) is used for the uplink-downlink resources may be assigned by using an adaptive Modulation and Coding Scheme (MCS) selected by the base station scheduler, which is conducive to reducing complexity.

In the block 202, for the TDD system in which the uplink-downlink subframe distribution can be flexible configured, the CRS may be sent or may be not sent in different downlink subframes.

If the flexible subframe is the uplink subframe in the SIB1 backward uplink-downlink configuration, the above first method for processing the CRS is used, i.e. when the current duplex direction is the downlink direction, the data area of the flexible subframe does not send the CRS; the above second method for processing the CRS is used, i.e. when the current duplex direction is the downlink direction, no CRS is sent in the whole flexible subframe; by using the two methods, the PDSCH transmission of the UE can only be demodulated based on DeModulation Reference Signal (DMRS).

If the flexible subframe is the downlink subframe in the SIB1 backward uplink-downlink configuration, if the CRS is stored in the data area of the flexible subframe according to the SIB1 backward uplink-downlink configuration, the channel estimation of the PDSCH transmission may be based on the CRS or based on the DMRS. The present invention provides that UE downlink transmission modes are configured for different types of CRS configurations of the downlink subframes.

For the downlink subframes with the CRS in the subframe data part, which include the normal subframe fixedly used for the downlink transmission and the flexible subframe configured as the normal downlink subframe in the SIB1 backward uplink-downlink configuration, one of the transmission modes based on the CRS or based on the DMRS respectively in the LTE system may be configured.

For the downlink subframes without the CRS in the subframe data part, which include the MBSFN subframe fixedly used for the downlink transmission, the flexible subframe configured as the MBSFN subframe in the SIB1 backward uplink-downlink configuration and the flexible subframe which is currently used for the downlink transmission and is configured as the uplink subframe in the SIB1 backward uplink-downlink configuration, only the PDSCH transmission mode based on the DMRS can be configured. For example, one of the downlink transmission modes 7, 8 and 9 defined in the LTE system.

Or for all the downlink subframes, no matter whether the downlink subframes has the CRS in the subframe data part, or no matter whether the subframe is the normal subframe fixedly used for the downlink transmission or is the flexible subframe currently used for the downlink transmission, the PDSCH transmission mode based on the demodulation of the DMRS is configured for all the downlink subframes. For example, one of the downlink transmission modes 7, 8 and 9 defined in the LTE system.

If the flexible subframe is the uplink subframe in the SIB1 backward uplink-downlink configuration, the above second method for processing the CRS is used, i.e. when the current duplex direction is the downlink direction, no CRS is sent in the whole flexible subframe. Another problem to be considered is how to send downlink scheduling control information and the uplink scheduling control information. For the downlink subframe in the SIB1 backward uplink-downlink configuration, the PDCCH may be sent by the control area in the front of the subframe or the E-PDCCH may be sent in the data area of the subframe. For the flexible subframe, if the flexible subframe is the uplink subframe in the SIB1 backward uplink-downlink configuration, when the current duplex direction is the downlink direction, the PDCCH can not be sent because there is no CRS of full bandwidth. One possible solution includes scheduling uplink-downlink data according to the E-PDCCH. According to different system designs, there may be Enhanced-Physical Control Format Indicator Channel (E-PCFICH) and Enhanced Physical HARQ indicator channel (E-PHICH). In the other possible solution, cross-subframe scheduling is performed for the flexible subframe, that is, the cross-subframe scheduling is performed for these flexible subframes via the downlink subframe (including the downlink subframe with the fixedly downlink direction and the flexible subframe configured as the downlink subframe in the SIB1 backward uplink-downlink configuration) in the SIB1 backward uplink-downlink configuration or via the downlink subframe fixedly used for the downlink direction.

In the block 202, if the uplink-downlink transmission of the flexible subframe is scheduled via the E-PDCCH, another problem is whether to assign E-PDCCH public search space in the flexible subframe with the downlink direction as the current duplex direction. In the LTE system, the control channel in the public search space is mainly used to assign the PDSCH for sending broadcast information and used in the random access procedure etc. If the flexible subframe is configured as the uplink subframe in the SIB1 backward uplink-downlink configuration, when being in the downlink direction, the flexible frame may only support UE specific E-PDCCH Search Space (USS) rather than the cell-common E-PDCCH Search Space (CSS). In the system, the control channel to be sent in the CSS is concentratedly sent in the subframe which is configured as the downlink subframe in the SIB1 backward uplink-downlink configuration, or concentratedly sent in the downlink subframe with fixed downlink direction. Or all of the subframes support both the USS and CSS, according to the above second method for configuring the CRS, if the flexible subframe is the uplink subframe in the SIB1 backward uplink-downlink configuration, when being in the downlink direction, the flexible subframe sends the E-PDCCH in both the CSS and USS. Detailed method for configuring the CSS and USS are not limited in the present invention.

For the flexible subframe, if the flexible subframe is the uplink subframe in the SIB1 backward uplink-downlink configuration, when the current duplex direction is the downlink direction, the above second method for processing the CRS is used, i.e. when the current duplex direction is the downlink direction, no CRS is sent in the whole flexible subframe. There is no PDCCH in the flexible subframe, all of the OFDM symbols in the subframe can be used for the PDSCH transmission, so as to maximize available resources; or starting OFDM symbols of the E-PDCCH and PDSCH are configured via signaling which may be cell specific broadcast signaling, so that an starting location is the same for all the UEs supporting the flexibly changing uplink-downlink subframe distribution in the cell; or the signaling may be UE specific RRC signaling, so that different UEs has different starting locations; or it is pre-defined in specification that the mapping of the E-PDCCH and the PDSCH starts from the k^{th} (k>0) OFDM symbol. The OFDM symbol of the E-PDCCH and that of the PDSCH may be the same or not. For the flexible subframe, if the adjacent cell performs the uplink transmission and sends the PUCCH signal, for the purpose of avoid the interference between the PUCCH of the adjacent cell and the PDSCH of this cell, one method used by the base station includes: for the flexible subframe used for the downlink transmission, if the adjacent cell performs uplink transmission in this flexible subframe and needs to send the PUCCH, the base station scheduler of this cell avoid to assign PRB overlap with the PUCCH for the PDSCH transmission.

For the flexible subframe, when the current duplex direction is the uplink direction, the following method may be used to schedule the PUSCH in the flexible subframe used for the uplink transmission. The uplink scheduling control signaling of the flexible subframe may be sent only from the subframe fixedly used as the downlink subframe; or the uplink scheduling control signaling of the flexible subframe may be sent only from the subframe which is configured as the downlink subframe in the SIB1; or the uplink scheduling control signaling of the flexible subframe may be sent from the subframe fixedly used as the downlink subframe and the flexible subframe currently used for the downlink direction.

Corresponding to the processing method on the base station side, FIG. 4 is a schematic flowchart illustrating processing on a UE side according to the present invention.

In block 401: UE receives downlink control information sent by a base station. For the subframe with a variable duplex direction, a transmission method in the subframe is determined according to the duplex direction in the SIB1 backward uplink-downlink configuration and the downlink control information sent by the base station.

In block 402: the UE sends uplink data or receives downlink data according to the downlink control information sent by the base station.

Specifically, in block 401:

for the subframe without the variable duplex direction, when the duplex direction is the downlink direction in the SIB1 backward uplink-downlink configuration, the subframe works according to CRS configuration of the subframe in the SIB1 backward uplink-downlink configuration.

For the subframe with the variable duplex direction, when the current duplex direction is the downlink direction, if the subframe is configured as the downlink subframe in the SIB1 backward uplink-downlink configuration, the subframe also works according to the CRS configuration of the subframe in the SIB1 backward uplink-downlink configuration. When the subframe is a normal downlink subframe, the CRS is sent in the whole subframe, so that downlink data transmission is processed according a method in the normal downlink subframe. When the subframe is the MBSFN subframe, the CRS is sent in the first one or two OFDM symbols of the subframe, so that the downlink data transmission is processed by using a method of the MBSFN subframe.

For the subframe with the variable duplex direction, when the current duplex direction is the downlink direction, if the subframe is configured as the uplink subframe in the SIB1 backward uplink-downlink configuration, corresponding to the processing method on the base station side, the downlink transmission in such flexible subframe may be processed according to the following three methods.

In the first method, for such flexible subframe, the CRS is configured according to the MBSFN subframe, that is, the CRS is sent only in the first one or two OFDM symbols of the subframe, so that the downlink data transmission is processed by using a method of the MBSFN subframe.

In the second method, for such flexible subframe, no CRS is sent in the whole subframe, so as to completely avoid the interference between cells caused by the CRS in the flexible subframe used for the downlink transmission, and avoid reducing of the channel estimation performance caused by the interference for the CRS.

In the third method, for such flexible subframe, the CRS is configured according to the normal downlink subframe, so that the downlink data transmission is processed according to the method in the normal downlink subframe.

The advantages of the first method include that: the backward compatible control channel of the control area of the subframe (PCFICH, PHICH and PDCCH) still can be sent, and the system in which the uplink-downlink subframe distribution can be flexibly configured may work completely according to the backward compatible control channel, at the same time, the uplink-downlink data transmission can be scheduled by using the Enhanced-PDCCH (E-PDCCH). In addition, by using this method, the CRS is only remained in the control area of the subframe, and thus the interference of the CRS is controlled to a certain extent.

The advantages of the second method include that: the CRS is totally cancelled from the subframe, and thereby avoiding the interference caused by the CRS for the uplink transmission of other cells, and avoiding the interference for the CRS of the cell caused by the uplink transmission of other cells, which further affects precision of the channel estimation.

If such flexible subframe is the uplink subframe in the SIB1 backward uplink-downlink configuration, it may be pre-defined in the specification that one of the above three methods is used when the duplex direction is the downlink direction. The second method above is optimal from the point of view of interference suppression.

In addition, if such flexible subframe is the uplink subframe in the SIB1 backward uplink-downlink configuration, the UE can obtain the CRS configuration used when the duplex direction of the subframe is the downlink direction via receiving base station signaling. For example, one of the above three methods may be indicated by using a high layer signaling. Or, the system only supports two of the three methods, one of the two methods may be indicated by using the high layer signaling. For example, by using the high layer signaling, it may be configured that the CRS is configured according the first or third method, or according to the first or second method, or according to the second or third method. The high layer signaling may be broadcast signaling and thus may be applied for all of the UEs which work in the flexible subframe mode in the cell; or the high layer signaling may be UE specific RRC signaling, and thus each UE in the cell may be configured respectively.

In the block 401, for the TDD system in which the uplink-downlink subframe distribution can be flexible configured, the interference in the subframe with fixed duplex direction and the interference in the subframe with flexible duplex direction are different. Specifically, the interference in the subframe with fixed downlink direction and the interference in the flexible subframe with the downlink direction as the current duplex direction are different; the interference in the subframe with fixed uplink direction and the interference in the flexible subframe with the uplink direction as the current duplex direction are different. Hence, different subframes have different best transmission modes. In one processing method, different transmission modes are respectively configured for the subframe with fixed duplex direction and the flexible subframe with the same duplex direction as the current duplex direction. For example, the subframe with fixed downlink direction is configured to support a downlink MIMO transmission mode, while the flexible subframe with the downlink direction as the current duplex direction is configured to only support a downlink transmission mode of transmit diversity; or the subframe with fixed uplink direction is configured to support uplink MIMO transmission mode, while the flexible subframe with the uplink direction as the current duplex direction is configured to only support a uplink transmission mode of single antenna. Or in another processing method, the same transmission mode is configured for all of the subframes with the same duplex direction. For example, the base station scheduler guarantees the proper adaptive MCS is used for the uplink-downlink resource allocation, which is conducive to reducing complexity.

In the block 401, for the TDD system in which the uplink-downlink subframe distribution can be flexible configured, the CRS may be sent or may be not sent in different downlink subframes.

If the flexible subframe is the uplink subframe in the SIB1 backward uplink-downlink configuration, the above first method for processing the CRS is used, i.e. when the current duplex direction is the downlink direction, the data area of the flexible subframe does not send the CRS; the above second method for processing the CRS is used, i.e. when the current duplex direction is the downlink direction, no CRS is sent in the whole flexible subframe; by using the two methods, the PDSCH transmission of the UE can only be demodulated based on DMRS.

If the flexible subframe is the downlink subframe in the SIB1 backward uplink-downlink configuration, if the CRS is stored in the data area of the flexible subframe according to the SIB1 backward uplink-downlink configuration, the channel estimation of the PDSCH transmission may be based on the CRS or based on the DMRS. The present invention provides that UE downlink transmission modes are configured for different types of CRS configurations of the downlink subframes.

For the downlink subframes with the CRS in the subframe data part, which include the normal subframe fixedly used for the downlink transmission and the flexible subframe configured as the normal downlink subframe in the SIB1 backward uplink-downlink configuration, one of the transmission modes based on the CRS or based on the DMRS respectively in the LTE system may be configured for the UE.

For the downlink subframes without the CRS in the subframe data part, which include the MBSFN subframe fixedly used for the downlink transmission, the flexible subframe configured as the MBSFN subframe in the SIB1 backward uplink-downlink configuration and the flexible subframe which is currently used for the downlink transmission and is configured as the uplink subframe in the SIB1 backward uplink-downlink configuration, only the PDSCH transmission mode based on the DMRS can be configured for the UE. For example, one of the downlink transmission modes 7, 8 and 9 defined in the LTE system.

Or for all the downlink subframes, no matter whether the downlink subframes has the CRS in subframe data part, or no matter whether the subframe is the normal subframe fixedly used for downlink transmission or is the flexible subframe currently used for the downlink transmission, the PDSCH transmission mode based on the DMRS demodulation is configured for the UE in all the downlink subframes. For example, one of the downlink transmission modes 7, 8 and 9 defined in the LTE system.

If the flexible subframe is the uplink subframe in the SIB1 backward uplink-downlink configuration, the above second method for processing the CRS is used, i.e. when the current duplex direction is the downlink direction, no CRS is sent in the whole flexible subframe. Another problem to be considered is how to send downlink scheduling control information and the uplink scheduling control information. For the downlink subframe in the SIB1 backward uplink-downlink configuration, the PDCCH may be sent by the control area in the front of the subframe or the E-PDCCH may be sent in the data area of the subframe. For the flexible subframe, if the flexible subframe is the uplink subframe in the SIB1 backward uplink-downlink configuration, when the current duplex direction is the downlink direction, the PDCCH can not be sent because there is no CRS of full bandwidth. One possible solution includes UE detects the E-PDCCH for scheduling uplink-downlink data. According to different system designs, there may be E-PCFICH and E-PHICH. In the other possible solution, cross-subframe scheduling is performed for the flexible subframe, that is, detecting the downlink control information for performing the cross-subframe scheduling for these flexible subframes via the downlink subframe (including the downlink subframe with the fixedly downlink direction and the flexible subframe configured as the downlink subframe in the SIB1 backward uplink-downlink configuration) in the SIB1 backward uplink-downlink configuration or via the downlink subframe fixedly used for the downlink direction.

In the block 401, if the downlink transmission of the flexible subframe is scheduled via the E-PDCCH, another problem is whether to assign E-PDCCH public search space in the flexible subframe with the downlink direction as the current duplex direction. In the LTE system, the control channel in the public search space is mainly used to assign the PDSCH for sending the broadcast information and used in the random access procedure etc. If the flexible subframe is configured as the uplink subframe in the SIB1 backward uplink-downlink configuration, the flexible frame may only support USS rather than the CSS when being in the downlink direction. The UE detects the control channel to be sent in the CSS in the system concentratedly in the subframe which is configured as the downlink subframe in the SIB1 backward uplink-downlink configuration, or detects the control channel to be sent in the CSS in the system concentratedly in the downlink subframe with fixed downlink direction. Or the UE support both the USS and CSS in all of the subframes, according to the above second method for configuring the CRS, if the flexible subframe is the uplink subframe in the SIB1 backward uplink-downlink configuration, when being in the downlink direction, the UE detects the E-PDCCH in both the CSS and USS. Detailed method for configuring the CSS and USS are not limited in the present invention.

For the flexible subframe, if the flexible subframe is the uplink subframe in the SIB1 backward uplink-downlink configuration, when the current duplex direction is the downlink direction, the above second method for processing the CRS is used, i.e. when the current duplex direction is the downlink direction, no CRS is sent in the whole flexible subframe. There is no PDCCH in the flexible subframe, all of the OFDM symbols in the subframe can be used for the PDSCH transmission, so as to maximize available resources; or the UE receives starting OFDM symbols of the E-PDCCH and PDSCH configured via signaling which may be cell specific broadcast signaling, so that an starting location is the same for all the UE supporting the flexibly changing uplink-downlink subframe distribution in the cell; or the signaling may be UE specific RRC signaling, so that different UEs has different starting location; or it is pre-defined in specification that the mapping of the E-PDCCH and the PDSCH starts from the k^{th} (k>0) OFDM symbol. The OFDM symbol of the E-PDCCH and that of the PDSCH may be the same or not.

The current duplex direction of the flexible subframe may be obtained according other information. For example, when at least one of the following cases occurs, the UE may determine that the current duplex direction of the flexible subframe is the uplink direction.

The base station configures the UE to periodically send uplink CQI (Channel Quality Indicator) report or periodically send UE specific SRS (Sounding Reference Signal), if once transmission in the above periodical transmission needs to occupy the flexible subframe, the UE determines that the current duplex direction of the flexible subframe is the uplink direction.

The Random Access Channel (RACH) configured by the base station includes a certain flexible subframe, the UE determines that the current duplex direction of the flexible subframe is the uplink direction.

The UE detects uplink resource assignment control signaling for scheduling the PUSCH in the flexible subframe, the UE determines that the current duplex direction of the flexible subframe is the uplink direction.

The UE detects uplink resource assignment control signaling for scheduling non-periodical CSI (Channel State Information) information report in the flexible subframe and the SRS report triggered non-periodically, the UE determines that the current duplex direction of the flexible subframe is the uplink direction.

For the above cases, the UE performs corresponding uplink transmission in the flexible subframe.

For the flexible subframe, when the current duplex direction is the uplink direction, the following methods may be used to scheduling the PUSCH in the flexible subframe used for the uplink transmission. The UE may only detect the uplink scheduling control signaling of the flexible subframe from the subframe fixedly used as the downlink subframe; or the UE may detect the uplink scheduling control signaling of the flexible subframe from the subframe configured as the downlink subframe in the SIB1; or the UE may detect the uplink scheduling control signaling of the flexible subframe from the subframe fixedly used as the downlink subframe and the flexible subframe currently used for the downlink direction.

Corresponding to the above methods, the present invention also provides a base station shown in FIG. 5 and UE shown in FIG. 6. The base station and the UE are used to support flexibly changing a duplex direction of a subframe in a TDD system.

As shown in FIG. 5, the base station provided by the present invention includes an adjusting module 510 and a transceiving module 520.

The adjusting module 510 is adapted to adjust uplink-downlink subframe distribution in a frame structure of the base station, and schedule uplink-downlink channel resources for the UE.

The transceiving module 520 is adapted to receive and send uplink-downlink data of the UE, for a subframe with a variable duplex direction, configure a transmission method in the subframe according to a current duplex direction of the subframe and a duplex direction in SIB1 backward uplink-downlink configuration.

Even though each of the adjusting module (510) and the transceiving module (520), respectively, of the base station is illustrated as a separate module, both of the modules may be emplemented in one module, i.e., controller (not shown), which is equipped in the base station. Therefore, the controller of the base station may perform all operations for supporting flexibly changing duplex directions of subframe, explained above as embodiments of the base station.

As shown in FIG. 6, the UE provided by the present invention includes a detecting module 610 and a transceiving module 620.

The detecting module 610 is adapted to receive downlink control information sent by a base station, for the subframe with a variable duplex direction, determine a transmission method in the subframe according to a duplex direction of the subframe in a SIB1 backward uplink-downlink configuration and received downlink control information sent by the base station.

The transceiving module 620 is adapted to send uplink data or receive downlink data according to the downlink control information sent by the base station.

Even though each of the detecting module (610) and the transceiving module (620), respectively, of the UE is illustrated as a separate module, both of the modules may be emplemented in one module, i.e., controller (not shown), which is equipped in the UE. Therefore, the controller of the UE may perform all operations for supporting flexibly changing duplex directions of subframe, explained above as embodiments of the UE.

As can be seen, by using the solutions of the present invention, the interference for uplink transmission of other cells caused by the CRS is avoided, and the CRS of the cell is not interfered by the uplink transmission of the other cells, thereby reducing the interference caused by flexibly changing the duplex direction of the subframe and further improving channel estimation precision.

The foregoing is only preferred embodiments of the present invention. It should be noted that those skilled in the art may make improvement and modification within the principle of the present invention, and the improvement and modification should be covered in the protection scope of the invention.

1. A method for supporting flexibly changing a duplex direction of a subframe in a Time Division Duplexing (TDD) system, comprising:
adjusting, by a base station, uplink-downlink subframe distribution in a frame structure of the base station, and scheduling uplink-downlink channel resources for UE;
receiving and sending, by the base station, uplink-downlink data of the UE; and
for a subframe with a variable duplex direction, configuring a transmission method in the subframe according to a current duplex direction of the subframe and a duplex direction of the subframe in system information block 1 (SIB1) backward uplink-downlink configuration.

2. The method of claim 1, further comprising:
for the subframe with the variable duplex direction, when the current duplex direction is a downlink direction, if the subframe is configured as a downlink subframe in the SIB1 backward uplink-downlink configuration, working according to common reference signal (CRS) configuration of the subframe in the SIB1 backward uplink-downlink configuration.

3. The method of claim 1, further comprising:
for the subframe with the variable duplex direction, when the current duplex direction is a downlink direction, if the subframe is configured as an uplink subframe in the SIB1 backward uplink-downlink configuration, configuring CRS for the subframe according to a Multicast Broadcast Single Frequency Network (MBSFN) subframe.

4. The method of claim 1, wherein for the subframe with the variable duplex direction, when the current duplex direction is a downlink direction, if the subframe is configured as an uplink subframe in the SIB1 backward uplink-downlink configuration, no CRS is send in the subframe.

5. The method of claim 1, further comprising:
for the subframe with the variable duplex direction, if the subframe is configured as an uplink subframe in the SIB1 backward uplink-downlink configuration, indicating CRS configuration of the subframe when the duplex direction of the subframe is the downlink direction via a high layer signaling.

6. The method of claim 1, further comprising one of:
configuring different transmission modes for a subframe with a fixed duplex direction and a flexible subframe with the current duplex direction of which is identical with the fixed duplex direction; and
configuring same transmission modes for all of subframes with the same duplex direction.

7. The method of claim 1, further comprising one of:
for a downlink subframe with a CRS in a subframe data part, configuring one of a transmission mode based on a CRS and a transmission mode based on a DeModulation Reference Signal (DMRS) in a Long Term Evolution (LTE) system;
for a downlink subframe without the CRS in the subframe data part, configuring a Physical Downlink Shared Channel (PDSCH) transmission mode based on DMRS demodulation; and
for all of the downlink subframes, configuring the PDSCH transmission mode based on DMRS demodulation.

8. The method of claim 1, further comprising one of:
for the subframe with the variable duplex direction, if the subframe is configured as an uplink subframe in the SIB1 backward uplink-downlink configuration, when the current duplex direction is a downlink direction, scheduling uplink-downlink data based on a Enhanced-Physical Downlink Control Channel (E-PDCCH); and
for the subframe with the variable duplex direction, if the subframe is configured as an uplink subframe in the SIB1 backward uplink-downlink configuration, when the current duplex direction is a downlink direction, scheduling uplink-downlink data via a method based on cross-subframe scheduling.

9. The method of claim 1, further comprising one of:
for the subframe with the variable duplex direction, if the subframe is configured as an uplink subframe in the SIB1 backward uplink-downlink configuration, when the current duplex direction is a downlink direction, only supporting a UE specific E-PDCCH Search Space (USS) without supporting a cell-common E-PDCCH Search Space (CSS); and
for the subframe with the variable duplex direction, if the subframe is configured as an uplink subframe in the SIB1 backward uplink-downlink configuration, when the current duplex direction is a downlink direction, supporting both the USS and the CSS.

10. The method of claim 1, further comprising one of:
for the subframe with the variable duplex direction, if the current duplex direction is an uplink direction, sending uplink scheduling control signaling of the subframe with the variable duplex direction only via a subframe fixedly being a downlink subframe;
for the subframe with the variable duplex direction, if the current duplex direction is an uplink direction, sending uplink scheduling control signaling of the subframe with the variable duplex direction only via a subframe configured as a downlink subframe in the SIB1 backward uplink-downlink configuration; and
for the subframe with the variable duplex direction, if the current duplex direction is an uplink direction, sending uplink scheduling control signaling of the subframe with the variable duplex direction via a subframe fixedly being a downlink subframe and via a subframe with the variable duplex direction and a current duplex direction is a downlink direction.

11. A method for supporting flexibly changing a duplex direction of a subframe in a TDD system, comprising:
receiving, by UE, downlink control information sent by a base station, for a subframe with a variable duplex direction;
configuring a transmission method in the subframe according to a duplex direction of the subframe in system information block 1 (SIB1) backward uplink-downlink configuration and the downlink control information sent by the base station; and
sending, by the UE, uplink data or receiving downlink data, according to the downlink control information sent by the base station.

12. The method of claim 11, further comprising:
for the subframe with the variable duplex direction, when the current duplex direction is a downlink direction, if the subframe is configured as a downlink subframe in the SIB1 backward uplink-downlink configuration, working according to common reference signal (CRS) configuration of the subframe in the SIB1 backward uplink-downlink configuration.

13. The method of claim 11, further comprising:
for the subframe with the variable duplex direction, when the current duplex direction is a downlink direction, if the subframe is configured as an uplink subframe in the SIB1 backward uplink-downlink configuration, working according to CRS configuration of a Multicast Broadcast Single Frequency Network (MBSFN) subframe.

14. The method of claim 11, wherein for the subframe with the variable duplex direction, when the current duplex direction is a downlink direction, if the subframe is configured as an uplink subframe in the SIB1 backward uplink-downlink configuration, working according to that a CRS is not comprised in the subframe.

15. The method of claim 11, further comprising:
for the subframe with the variable duplex direction, if the subframe is configured as an uplink subframe in the SIB1 backward uplink-downlink configuration, receiving CRS configuration of the subframe indicated by a high layer signaling when the duplex direction of the subframe is the downlink direction.

16. The method of claim 11, further comprising one of:
configuring different transmission modes for a subframe with a fixed duplex direction and a flexible subframe with the current duplex direction of which is identical with the fixed duplex direction; and
configuring same transmission modes for all of subframes with the same duplex direction.

17. The method of claim 11, further comprising one of:
for a downlink subframe with a CRS in a subframe data part, configuring one of a transmission mode based on a CRS and a transmission mode based on a DeModulation Reference Signal (DMRS) in a Long Term Evolution (LTE) system;
for a downlink subframe without the CRS in the subframe data part, configuring a Physical Downlink Shared Channel (PDSCH) transmission mode based on DMRS demodulation; and
for all of the downlink subframes, configuring the PDSCH transmission mode based on DMRS demodulation.

18. The method of claim 11, further comprising one of:
for the subframe with the variable duplex direction, if the subframe is configured as an uplink subframe in the SIB1 backward uplink-downlink configuration, when the current duplex direction is a downlink direction, detecting E-PDCCH for scheduling uplink-downlink data; and
for the subframe with the variable duplex direction, if the subframe is configured as an uplink subframe in the SIB1 backward uplink-downlink configuration, when the current duplex direction is a downlink direction, detecting the downlink control information for scheduling the subframe by using a method based on cross-subframe scheduling.

19. The method of claim 11, further comprising one of:
for the subframe with the variable duplex direction, if the subframe is configured as an uplink subframe in the SIB1 backward uplink-downlink configuration, when the current duplex direction is a downlink direction, only supporting a USS without supporting a CSS; and
for the subframe with the variable duplex direction, if the subframe is configured as an uplink subframe in the SIB1 backward uplink-downlink configuration, when the current duplex direction is a downlink direction, supporting both the USS and the CSS.

20. The method of claim 11, further comprising one of:
for the subframe with the variable duplex direction, if the current duplex direction is an uplink direction, detecting uplink scheduling control signaling of the subframe with the variable duplex direction only from a subframe fixedly being a downlink subframe;
for the subframe with the variable duplex direction, if the current duplex direction is an uplink direction, detecting uplink scheduling control signaling of the subframe with the variable duplex direction only from a subframe configured as a downlink subframe in the SIB1 backward uplink-downlink configuration; and
for the subframe with the variable duplex direction, if the current duplex direction is an uplink direction, detecting uplink scheduling control signaling of the subframe with the variable duplex direction from a subframe fixedly being a downlink subframe and from a subframe with the variable duplex direction and a current duplex direction is a downlink direction.

21. A base station, used to support flexibly changing a duplex direction of a subframe in a TDD system, comprising:
an adjusting module, adapted to adjust uplink-downlink subframe distribution in a frame structure of the base station, and to schedule uplink-downlink channel resources for UE; and
a transceiving module, adapted to receive and send uplink-downlink data of the UE, for a subframe with a variable duplex direction, and to configure a transmission method in the subframe according to a current duplex direction of the subframe and a duplex direction in system information block 1 (SIB1) backward uplink-downlink configuration.

22. A UE, used to support flexibly changing a duplex direction of a subframe in a TDD system, comprising:
a detecting module, adapted to receive downlink control information sent by a base station, for the subframe with a variable duplex direction, and to determine a transmission method in the subframe according to a duplex direction of the subframe in system information block 1 (SIB1) backward uplink-downlink configuration and received downlink control information sent by the base station; and
a transceiving module, adapted to send uplink data or receive downlink data according to the downlink control information sent by the base station.
